(19) United States
(12) Patent Application Publication
(10) Pub. No.: US 2004/0071602 A1
(43) Pub. Date: Apr. 15, 2004

(54) Pipettor head adapter

(76) Inventor: Felix H. Yiu, Monrovia, CA (US)

Correspondence Address: CISLO & THOMAS, LLP, 233 WILSHIRE BLVD, SUITE 900, SANTA MONICA, CA, 90401-1211, US

(21) Appl. No.: 10/272,173

(22) Filed: Oct. 15, 2002

(51) Int. Cl. B01L 3/02

(52) U.S. Cl. 422/100; 422/919; 422/922; 422/929; 73/863.32; 73/864.01

(57) ABSTRACT

A pipettor head adapter allows the adaptation of pipettors having a set number of pipettor channels to successfully pipette microtiter trays having a different number of wells than the pipettor has pipettor channels. For example, in a pipettor having 384 channels for pipetting a 384 well microtiter tray, the pipettor head adapter of the present invention will allow a “stepping down” or adaptation, such that the pipettor with its 384 pipettor channels can successfully and reliably pipette microtiter trays having 96 wells. Such adaptation occurs without the need for special microtiter trays. Industry standard operations are then preserved, even though they were previously unavailable from such a pipettor.

### BACKGROUND OF THE INVENTION

1. Field of the Invention

This invention relates to pipetting operations and equipment, and more particularly to an adapter that allows a 384 channel pipettor to be used with 96-hole microtiter plates.

2. Description of the Related Art

Pipettes, pipettors, and pipetting are generally known in the art. Pipetting is generally the precise and accurate measurement, withdrawal, and transfer of small amounts of liquid for biological or other purposes. In biology, reactions and processes can take place in a very small vessel yet yield useful results. Consequently, it is common to experiment with a very large number of small samples simultaneously, with each sample having a slight variation from the other samples. Upon analysis, the best yield or results can be gauged for a wide spectrum of different criteria, such that a very productive or advantageous process or operation can be emphasized without the demand of significant or burdensome resources.

As biological processes are generally unpredictable due to (among other things) the presence and widespread use of enzymes and other biological chemicals, it becomes difficult to predict exactly which processes or which concentrations of which chemicals yield the best results under interesting circumstances. Consequently, it is left to the natural processes of the organisms or processes to indicate which specific variations are the most advantageous or the most interesting. Once small samples have been evaluated and tested, those of the most interest may be the subjects of additional research and investigation.

In the art, pipetting operations are used to measure and transfer small amounts of fluid in a precise and accurate fashion. In order to increase the efficiency of pipetting processes, several pipetting operations can be conducted simultaneously using microtiter trays and the like, each microtiter tray having 96 or 384 wells for the holding of fluid. Generally, a pipettor is able to pipette either one of such number of trays. For the 96 well microtiter tray, a grid of 8×12 is used. For 384 well microtiter trays, a 16×24 array is used.

Previously, the art has not provided a pipettor that well addresses both sets of microtiter trays. Additionally, adapters have not been present that would allow the use of one pipettor to avail itself of both types of trays.

The pipettor head adapter of the present invention resolves this problem by providing an adapter that allows a 384 pipette channel pipettor to be advantageously used with a 96 well microtiter tray. Conversely, the technology disclosed herein can be used to achieve a pipettor head adapter that enables a 96 pipette channel pipettor to pipette 384 well microtiter trays.

### SUMMARY OF THE INVENTION

The present invention provides means by which pipettors that are dedicated to one set of pipetting wells or channels can be adapted to also advantageously address microtiter plates of other numbers of wells. Generally, the difference or ratio between the number of pipettor channels and the number microtiter plate wells are multiples of one another. Specifically, in one embodiment, a pipettor having 384 pipetting channels can be adapted to also enable pipetting of microtiter plates having 96 wells.

One embodiment of the adapter is a “step down” adapter, as the higher number of channels available through the pipettor are stepped down to a lower number of wells in the microtiter tray. However, the reverse may also be true where a lower number of pipettor channels can be adapted to enable pipetting of a higher number of microtiter plate wells. However, with such a step up adapter, care must be taken not to cross-contaminate samples via the shared gas—fluid communication between separate pipette tips. Additionally, smaller volumes of liquid can be pipetted with each pipette tip in a “step up” configuration.

In a pipettor having a lockable head, a flat insert is used that on one side sealingly engages (upon compression) the available number of pipettor head channels used for pipetting. The adapter then steps down the resulting number of pipette tips by sharing a matched number of pipettor channels to a number of projections, or pipette tip receivers. The pipette tip receivers may be individual projections, or protuberances, to which disposable pipette tips are temporarily attached in a sealable or sealed manner.

In this way, the adapter then mediates the disparity between the pipettor channels and the desired number of microtiter wells. Generally, both are subject to industry standards with microtiter plates generally having 96 or 384 wells depending upon the volume and distribution of the wells.

In providing a pipettor head adapter, pipettors which are generally dedicated to a certain number of pipette tips and wells in a microtiter plate tray are able to pipette microtiter trays having different numbers of wells. Consequently, pipettors which previously could not be used for different microtiter plate well numbers can now be used for such microtiter plates.

### OBJECTS OF THE INVENTION

It is an object of the present invention to provide a pipettor head adapter that adapts pipettors to microtiter or plate trays having a different number of wells than the pipettor head has channels.

It is yet another object of the present invention to provide a pipettor head adapter that is easy to use.

It is yet another object of the present invention to provide a pipettor head adapter that is operable with a number of pipettors.

It is yet another object of the present invention to provide a pipettor head adapter that is readily used in conjunction with disposable pipette tips.

These and other objects and advantages of the present invention will be apparent from a review of the following specification and accompanying drawings.

### BRIEF DESCRIPTION OF THE DRAWINGS

FIG. 1 is a lower left side view of the pipettor head adapter of the present invention showing a disposable pipette tip in phantom in a rear right corner thereof.

FIG. 2 is an upper right perspective view of the pipettor head adapter of FIG. 1.

FIG. 3 is a lower front and generally perspective view of pipettor channel openings present in a pipettor.

FIG. 4 is a right perspective view of a pipettor having pipettor channels such as those shown in FIG. 3.

FIG. 5 shows upper perspective views of a 96 well microtiter tray above a 384 well microtiter tray.

FIG. 6 shows the pipettor of FIG. 4 with the adapter of FIG. 1 in place when fitted with disposable pipette tips.

FIG. 7 shows a cross-sectional view of the pipettor head adapter of FIG. 1 taken along line 7-7 thereof, as indicated in the lower part of FIG. 7. The upper part of FIG. 7 is a cross-sectional view of the pipettor block with pipettor channels such as that shown in FIG. 3.

FIG. 8 is an upper left perspective view of an alternative embodiment of the pipettor adaptor of the present invention providing a 3 to 1 step down ratio.

FIG. 9 is a partial and cross-sectional view of the channel paths for the adaptor shown in FIG. 8 taken along line 9-9.

FIG. 10 is a close-up view of the top portion of the adaptor shown in FIG. 8 as indicated by circle 10.

FIG. 11 is a top left perspective view of an alternative embodiment of the pipettor head adaptor having a step down ratio of 2 to 1.

FIG. 12 is a partial side cross sectional view of the pipettor head adaptor of FIG. 11 showing the channel construction of the pipettor head adaptor as well as used and unused pipettor head channels taken generally along line 12-12 of FIG. 11.

FIG. 13 is a partial close-up view of the upper side of the pipettor head adaptor of FIG. 11 taken generally along circle 13.

FIG. 14 is a side cross sectional view of an alternative embodiment of the pipettor head adaptor of FIG. 1 similar to that shown in FIG. 7. The upper part of FIG. 14 is a cross sectional view of an alternative embodiment of the pipettor block with sealing gaskets at the lower ends of the pipettor channels and the lower part of FIG. 14 is a cross sectional view of an alternative embodiment of the pipettor head adaptor which is adapted to receive removable pipette tips.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

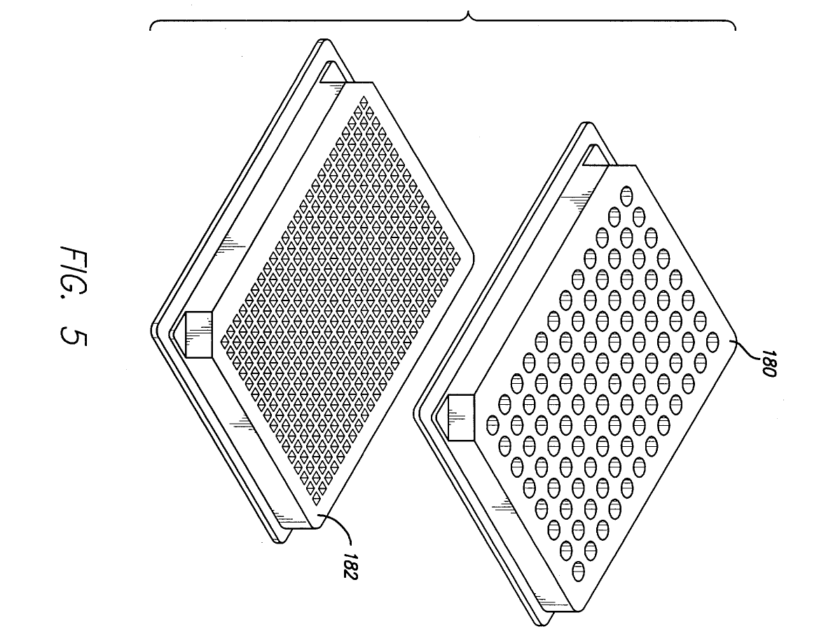

FIG. 1 shows the pipettor head adapter 100 of the present invention. The pipettor head adapter 100 has a number of projections or protuberances 102 with each projection 102 generally corresponding to a single well in a correspondingly numbered microtiter tray (FIG. 5). Each of the projections 102 has a distal seal 104 and a proximal seal 106 in order to provide double sealing for a disposable pipette tip shown in phantom in FIG. 1. The pipette tip 108 is generally friction fitted about the projection 102 so that the interior sides of the disposable pipette tip engage the distal and proximal seals 104, 106.

As is known in the art, several such pipette tips 108 may be engaged simultaneously by all available projections 102 when the adapter or other pipette-engaging mechanism is fitted with pipette tips 108 held in a pipette holder or the like (not shown). By pressing the adapter 100 and its projections 102 into the open pipette tips 108, the pipette tips 108 are then fitted by friction upon the projections 102 and securely sealed by the distal and proximal seals 104, 106.

Each pipette projection 102 terminates in an open end 110 through which fluid, particularly air or other gas, may flow. By raising and lowering the pressure in the pipette tip 108 via the projection opening 110, fluids, including biological samples, may be aspirated or dispensed by the pipette tip via its open distal end 112.

The pipettor head adapter 100 may have a handle 114 for easy gripping, engagement, and disengagement by a person's hand. The pipettor head adapter 100 may generally be made of surgical stainless steel or other autoclavable or sterilizable material with the seals 104, 106 made of an appropriately elastic and resilient material. The projections 102 are separated by a margin area 116 from the edge 118 of the adapter 100. The margin 116 allows the adapter 100 to be engaged and clamped to the pipettor as is described in more detail below.

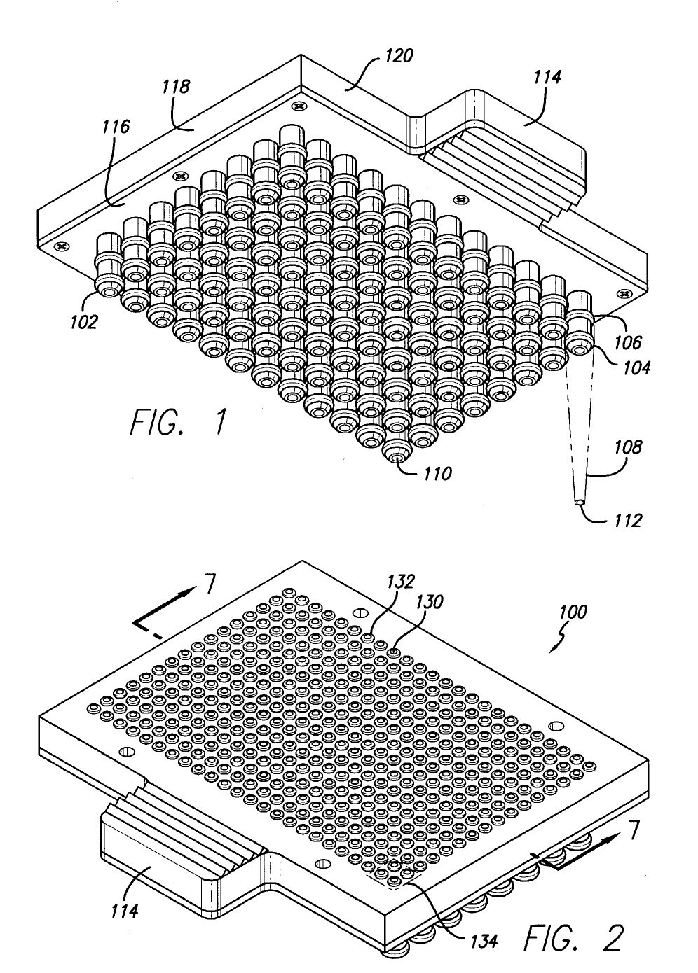

In FIG. 2, the upper side of the adapter 100 is shown with an array of pipette channel engagers in the form of 384 apertures 130 about each of which a resilient and rubbery seal 132 is disposed. The number of apertures 130 generally corresponds to a multiple (or divisional) of the projections 102 in the lower or bottom side of the adapter 100 as indicated in FIG. 1.

The apertures 130 with their seals 132 communicate with the projection openings 110, such that fluid traveling through the aperture 130 generally also flows through a corresponding projection opening 110.

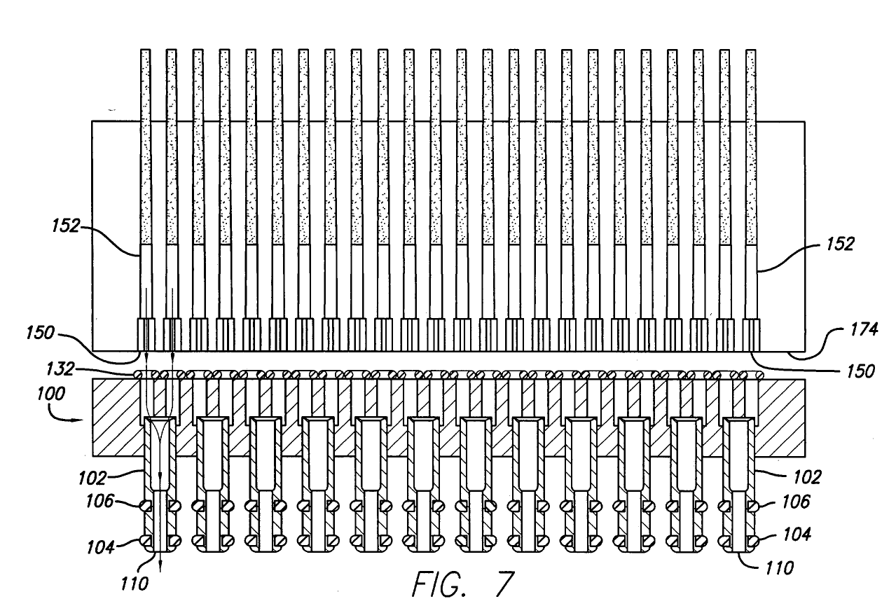

As shown in FIGS. 1 and 2, generally every four apertures 130 correspond to a single projection 102. As an example, in any corner of the upper apertures 130 appearing in FIG. 2, four apertures 130 in a well in that corner would generally correspond to the corresponding corner projection 102 in FIG. 1. As an example, in FIG. 2, the lower right 2×2 square of apertures 130 is designated by a square 134, which would generally correspond to the pipette tip 108 shown in phantom and its corresponding projection 102 as shown in FIG. 1. Visual inspection of FIG. 7 will also indicate the correspondence between the other apertures 130 and the projections 102 with their openings 110.

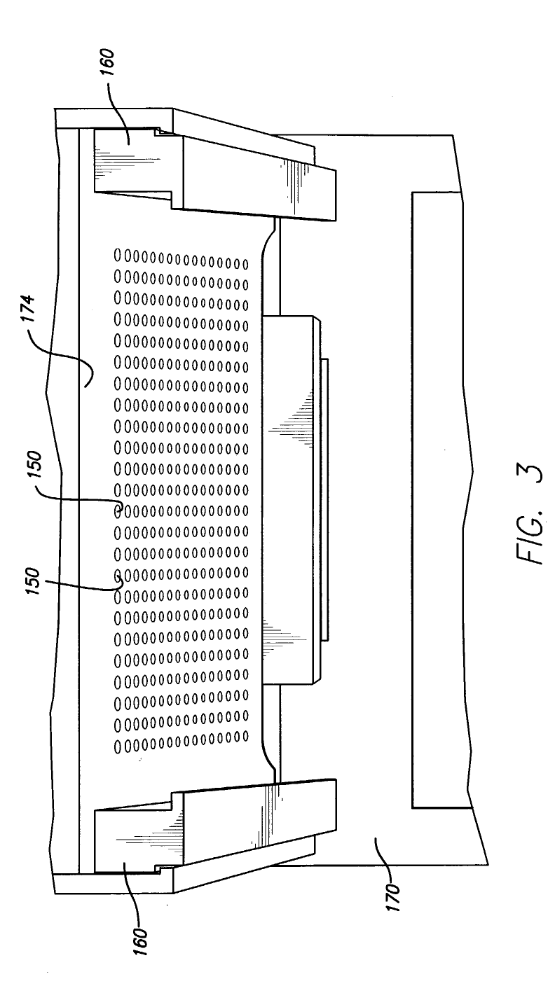

In FIG. 3, a number of pipettor channel apertures 150 are shown that lead to channels 152 (FIG. 7). The pipettor channel openings 150 correspond on a 1-to-1 basis to the adapter's upper apertures 130. Consequently, in order to properly operate pipette tips 108 connected to projections 102, alignment and registration between the pipettor channel openings 150 and the upper adapter apertures 130 must be made. The pipettor head adapter 100 is constructed and machined such that there is a high degree of registration and correspondence between the pipettor channel openings 150 and the upper adapter apertures 130.

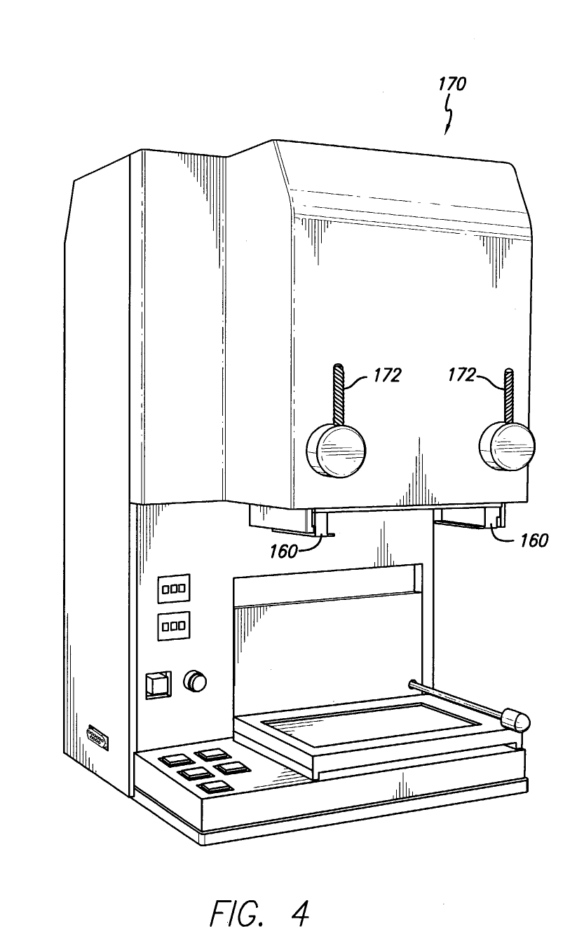

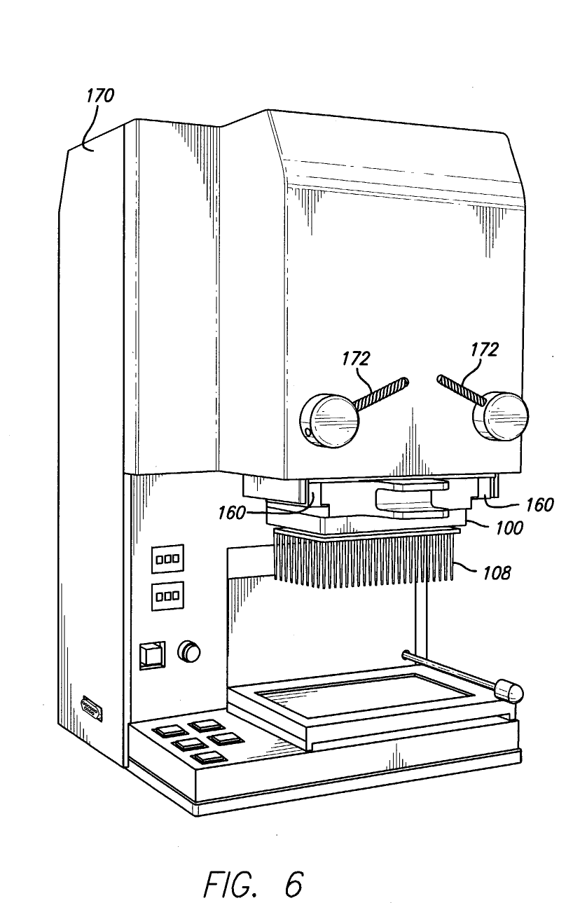

As shown in FIG. 3, right and left holders 160 are present that generally operate as a set of vertically-operating jaws. The holders are generally spaced apart and are disposed with respect to the pipettor channel openings 150 so that the main adapter plate, or chassis, 120 fits between the two holders 160 with a minimal amount of clearance sufficient to enable easy sliding of the adapter 100 between the two holders 160. The adapter 100 is also constructed and machined so that there is a high degree of cooperation between the adapter 100, the holders 160, and the pipettor 170 itself. The holders 160 are shown in FIG. 4 in conjunction with the pipettor 170. Vertical operation of the holders allow them to clamp the adapter 100 up and against the pipettor channel openings 150 when the lock clamp handles 172 are turned to lift the holders 160 vertically. The adapter 100 is then locked against the pipettor and the pipettor channel openings 150 as shown in FIG. 6.

Once the adapter 100 is clamped in place against the flat pipettor opening surface 174 (FIG. 3), the adapter is then ready to perform pipetting operations on a tray such as that shown in FIG. 5 having 96 wells 180 as opposed to the higher number of wells present in a 384 well tray 182. As indicated in the drawing figures, the pipettor 170 has pipettor channels 152 in number corresponding to that for the 384 well microtiter tray 182. It would otherwise be unable to effect pipetting upon the 96 well tray 180 as the higher number of pipette tips would not be well disposed in order to properly aspirate fluids in the 96 well tray. The possibility of leaving some pipette tips off of a 384 tip head (and only use 96 tips in a 384 tip head) would necessitate that such present pipette tips are off center with respect to the 96 well tray 180 wells, and it is more advantageous to have such pipette tips centrally located whenever pipetting operations are performed. Consequently, the adapter of the present invention not only allows a step down adaptation between a 384 well pipettor to a 96 well microtiter tray, but it also appropriately alters the geometry and disposition of the pipette tips that are engaged by the adapter 100.

In order to release the pipettor head adapter 100, the lock clamp handles 172 are disengaged to lower the holders 160. The pipettor head adapter 100 may then be withdrawn from between the holders 160 and replaced by a regular pipetting plate head having a 1-to-1 correspondence between the pipettor channel openings 100 and the wells in a 384 well microtiter tray 182.

Alternatively, and along the lines discussed above, additional microtiter trays may be subject to adaptation by quoting the principles set forth herein. For example, a 1536 channel pipettor could be stepped down in order to properly pipette microtiter trays having 384 wells and/or 96 wells by the construction and operation of an appropriate “step down” adapter. Additionally, “step up” adapters may be realized by generally reversing the roles played by the projections 102 and the apertures 130 as set forth above.

For example, for a 96 channel pipettor, each channel could be relegated to the operation of four projections so as to step up the number of pipette tips that could be constructively operated by the 96 channel pipettor. The same is similarly true for an adapter that would allow the pipetting of a 1536 well microtiter tray. For a 96 channel pipettor, each channel would then operate 16 pipette tips and 16 corresponding projections.

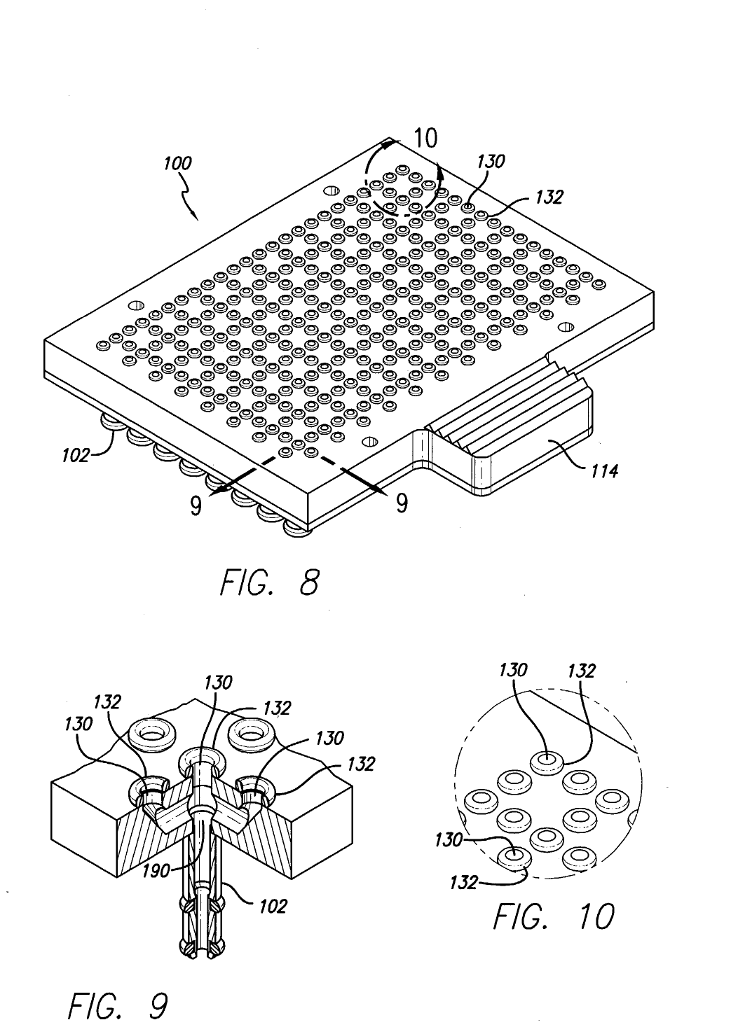

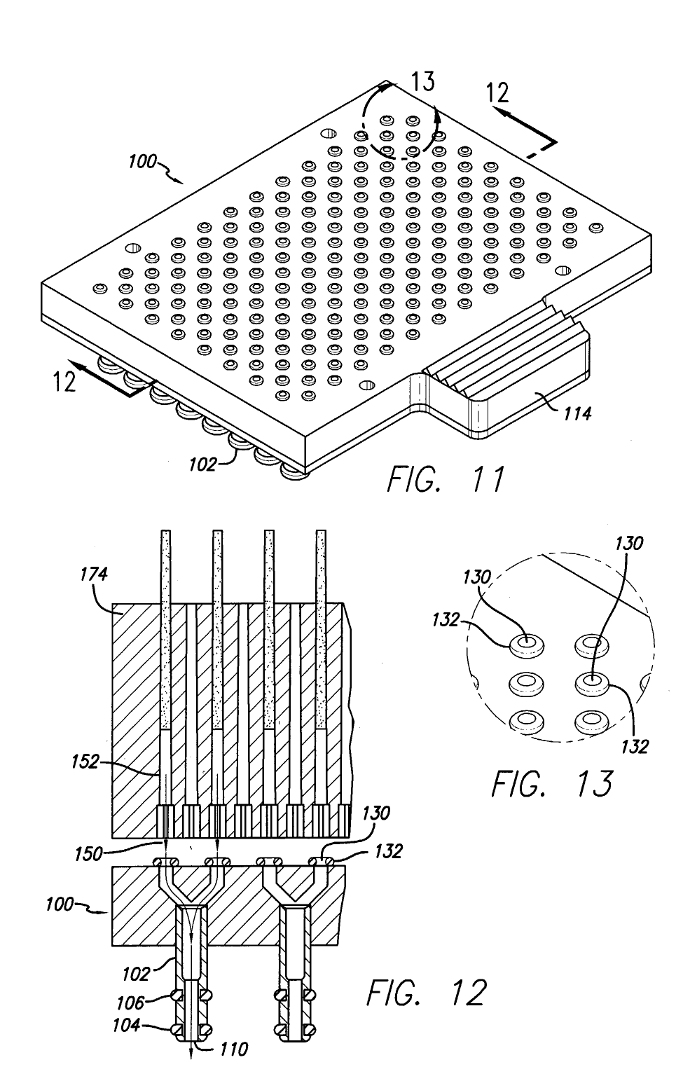

FIGS. 8-12 show alternative embodiments of the present invention indicating the implementation of the present invention for alternative conversion ratios. Both FIGS. 8 and 11 have undersides that look similar, if not exactly the same as, FIG. 1. In FIGS. 8 and 11, a number of protuberances project downwardly from the bottom of the pipettor head adaptor 100. However, in FIG. 8, for every three pipettor head channels, only one pipette tip 108 and pipette tip projection 102 is associated therewith. This leaves one single channel of the pipettor head adaptor unused out of every four pipettor head channels while the other three pipettor head channels are then used to control fluid flow and pressure in the corresponding single projection 102 and pipette tip 108. FIG. 9 shows the association of the three apertures 130 which correspond to a single pipette aperture 190. As for the previous embodiment, aperture seals 132 are present about each of the apertures so that under compression, the seals 132 seal the apertures 130 with respect to the pipettor surface 174 of the pipettor 170. FIG. 10 is a close-up view of the spacing geometry used for the apertures 130 and seals 132.

In FIG. 11, a similar pipettor head adaptor 100 is shown having a 2:1 step down ration between the pipettor head channels 152 and the pipette projections 102.

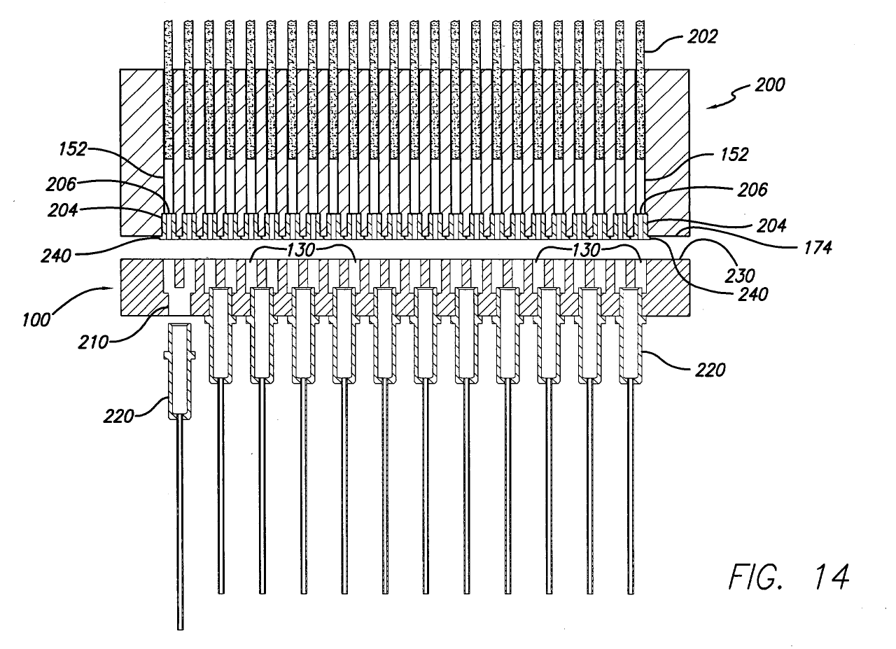

This is also seen in FIG. 12 where for purposes of illustration, pistons have been omitted from the pipettor head channels 152 that are not associated with core structures 130 in the pipettor head adaptor 100. In the embodiment of the pipettor head adaptor 100 shown in FIG. 11, for every two pipettor channels 152, one is not associated with a corresponding pipette tip projection 102 or aperture 130. FIG. 13 shows a closer view of the spacing geometry shown on the top of the pipettor head adaptor 100 of FIG. 11.

Accordingly, the pipettor head adaptor 100 of the present invention allows pipettors 170 to engage different numbers of microtiter wells than the number of pipettor channels 152 the pipettor 170 has by design. This increases the flexibility and utility of such pipettors 170 and provides the research professional with additional options in performing pipetting operations.

FIG. 14 shows an alternative embodiment of both a pipettor head having a pipettor block 200 with a series of pipettor channels 152. Pistons 202 travel through the pipettor channels 152 in order to increase or decrease pressure. The pipettor channels 152 terminate in gasket tips 204 which, as shown in FIG. 14, project into the pipettor channel 152 and extend outwardly therefrom in order to provide a circumscribing flange around the interior channel 206 of the gasket tip 204. Air or other fluid is able to move under the motivation of the pistons 202 through the pipettor channels 152 and into and out of the pipettor channel 152 via the gasket tips 204 and the gasket tip channels 206.

The pipettor head adaptor 100 shown in FIG. 14 is similar to that shown in FIG. 7. Namely, a number of apertures 130 are provided in connected fashion so that the flow or pressure from a specified number of pipettor channels 152 are then transmitted to individual ones of corresponding pipettor head adaptor channels 210. In the case of the alternative embodiment shown in FIG. 14, the pipettor head adaptor channels 210 also serve as means by which removable pipette tips 220 may be removably attached to the pipettor head adaptor 100. As for the other embodiments of the present pipettor head adaptor 100, the pipettor head adaptor 100 shown in FIG. 14 may serve to either step down or step up the number of channels available for pipetting as opposed to the fixed number of pipettor channels 152 present in the pipettor block 200.

The pipette tips 220 may be fixed to the pipettor head adaptor 100 by friction fit, a detent locking mechanism, or otherwise. The use of removable pipette tips 220 allows them to be made disposable or the like so that sterility and sanitary considerations can be met.

While the pipettor head adaptor 100 in FIG. 7 shows a series of gaskets or seals 132 on the upper surface of the pipettor head adaptor 100, these gaskets or seals are replaced (in FIG. 14) by the gasket tips 204 at the surface of the pipettor block 200 adjacent that of the pipettor head adaptor 100. The gasket tips 204 extend outwardly to circumscribe the pipettor channel 152 and when pressed against the flat surface 230 of the pipettor head adaptor 100, the gasket tips 204 with their compressible and circumscribing flange 240 act as seals much in the same manner as the seals 132 as shown in FIG. 7.

In operation, the pipettor head adaptor 100 as shown in FIG. 14 operates in a similar manner as to described previously above especially with regards to the engagement of the pipettor head adaptor 100 by the pipettor 170. Certain automated processes may be put into place whereby the pipettor head adaptor 100 is fitted with disposable or removable pipettor tips 220, engaged by the pipettor 170, disengaged by the pipettor 170 and having the removable or disposable pipettor tips 220 removed from the pipettor head adaptor 100, all on an automatic or automated basis.

While the present invention has been described with regards to particular embodiments, it is recognized that additional variations of the present invention may be devised without departing from the inventive concept.

What is claimed is:

1. An adapter for a pipettor that enables use of a number of pipette tips different than a number of pipette channels of the pipettor, the adapter comprising:
a chassis;
a pipette tip receiver coupled to said chassis, said pipette tip receiver adapted to engage a pipette tip; and
a plurality of pipette channel engagers coupled to said chassis and adapted to engage corresponding pipette channels of the pipettor, said pipette channel engagers in communication with said pipette tip receiver; whereby
a pipette tip is engageable by said pipette tip receiver and controlled by operation of said plurality of pipette channel engagers by the corresponding number of pipette channels.

2. An adapter for a pipettor that enables use of a number of pipette tips different than a number of pipette channels of the pipettor as set forth in claim 1, further comprising:
said chassis being generally flat with said pipette tip receiver on a first side of said chassis and said plurality of pipette channel engagers on an opposite side of said chassis.

3. An adapter for a pipettor that enables use of a number of pipette tips different than a number of pipette channels of the pipettor as set forth in claim 1, further comprising:
said pipette tip receiver being a projection about which a pipette tip may be fitted.

4. An adapter for a pipettor that enables use of a number of pipette tips different than a number of pipette channels of the pipettor as set forth in claim 3, further comprising:
first and second seals circumscribing said pipette tip receiver; whereby
a pipette tip may be engaged by said pipette tip receiver by friction fit over said first and second seals.

5. An adapter for a pipettor that enables use of a number of pipette tips different than a number of pipette channels of the pipettor as set forth in claim 1, further comprising:
said chassis defining an adapter channel as said pipette tip receiver, said adapter channel receiving said pipette tip and into which said pipette tip may be fitted.

6. An adapter for a pipettor that enables use of a number of pipette tips different than a number of pipette channels of the pipettor as set forth in claim 1, further comprising:
said pipette tip receiver defining a central channel; and
said chassis defining separate channels as said plurality of pipette channel engagers, said separate channels in communication with said central channel; whereby
flow through said separate channels of said chassis is transmitted to said central channel of said pipette tip receiver.

7. An adapter for a pipettor that enables use of a number of pipette tips different than a number of pipette channels of the pipettor as set forth in claim 6, further comprising:
said separate channels each having an open end;
said open ends of said separate channels each being sealable; whereby
a seal may be created between said plurality of pipette channel engagers and said corresponding pipette channels by aligned compression of the adapter against the pipettor to enable controlled flow through said corresponding pipette channels to said separate channels.

8. An adapter for a pipettor that enables use of a number of pipette tips different than a number of pipette channels of the pipettor as set forth in claim 7, further comprising:
said open ends of said separate channels each circumscribed by a sealing member to provide sealing between said plurality of pipette channel engagers and said corresponding pipette channels.

9. An adapter for a pipettor that enables use of a number of pipette tips different than a number of pipette channels of the pipettor as set forth in claim 7, further comprising:
said open ends of said separate channels each sealable by a sealing member circumscribing corresponding openings of said pipette channels to provide sealing between said plurality of pipette channel engagers and said corresponding pipette channels.

10. An adapter for a pipettor that enables use of a number of pipette tips different than a number of pipette channels of the pipettor as set forth in claim 1, further comprising:
said plurality of pipette channel engagers being in number selected from the group of numbers consisting of two, three, four and sixteen.

11. An adapter for a pipettor that enables use of a number of pipette tips different than a number of pipette channels of the pipettor, the adapter comprising:
a chassis, said chassis being generally flat and having a first side and an opposite side;
said chassis including a pipette tip receiver having a central channel on said first side of said chassis, said pipette tip receiver adapted to engage a pipette tip;
said chassis defining separate channels on said opposite side of said chassis adapted to engage corresponding pipette channels of the pipettor, said separate channels in communication with said central channel such that flow through said separate channels of said chassis is transmitted to said central channel of said pipette tip receiver;
said separate channels each having an open end; and
said open ends of said separate channels each being sealable such that a seal may be created between said separate channels and said corresponding pipette channels by aligned compression of the adapter against the pipettor to enable controlled flow through said corresponding pipette channels to said separate channels; whereby
a pipette tip is engageable by said pipette tip receiver and flow through said central channel is controlled by flow through said separate channels caused by flow through said corresponding number of pipette channels.

12. An adapter for a pipettor that enables use of a number of pipette tips different than a number of pipette channels of the pipettor as set forth in claim 11, the adapter further comprising:
said pipette tip receiver being a projection defining said central channel and about which a pipette tip may be fitted; and
first and second seals circumscribing said pipette tip receiver such that a pipette tip may be engaged by said pipette tip receiver by friction fit over said first and second seals.

13. An adapter for a pipettor that enables use of a number of pipette tips different than a number of pipette channels of the pipettor as set forth in claim 11, the adapter further comprising:
said chassis defining said central channel as said pipette tip receiver, said central channel receiving said pipette tip and into which said pipette tip may be fitted; and
said open ends of said separate channels each sealable by a sealing member circumscribing corresponding openings of said pipette channels to provide sealing between said separate channels and said corresponding pipette channels.

14. An adapter for a pipettor that enables use of a number of pipette tips different than a number of pipette channels of the pipettor as set forth in claim 11, further comprising:
said plurality of pipette channel engagers being in number selected from the group of numbers consisting of two, three, four and sixteen.

15. An adapter for a pipettor that enables use of a number of pipette tips different than a number of pipette channels of the pipettor, the adapter comprising:
a chassis;
a plurality of pipette tip receivers coupled to said chassis, said pipette tip receivers each adapted to engage a pipette tip; and
a pipette channel engager coupled to said chassis and adapted to engage a corresponding pipette channel of the pipettor, said pipette channel engager in communication with each of said plurality of pipette tip receivers; whereby
a plurality of corresponding pipette tips is engageable by said plurality of pipette tip receivers and controlled by operation of said pipette channel engager by the corresponding pipette channel.

16. An adapter for a pipettor that enables use of a number of pipette tips different than a number of pipette channels of the pipettor as set forth in claim 15, further comprising:
said chassis being generally flat with said plurality of pipette tip receivers on a first side of said chassis and said pipette channel engager on an opposite side of said chassis.

17. An adapter for a pipettor that enables use of a number of pipette tips different than a number of pipette channels of the pipettor as set forth in claim 15, further comprising:
said plurality of pipette tip receivers each being a projection about which a pipette tip may be fitted.

18. An adapter for a pipettor that enables use of a number of pipette tips different than a number of pipette channels of the pipettor as set forth in claim 17, further comprising:
first and second seals circumscribing each of said plurality of said pipette tip receivers; whereby
a pipette tip may be engaged by each of said plurality of said pipette tip receivers by friction fit over said first and second seals.

19. An adapter for a pipettor that enables use of a number of pipette tips different than a number of pipette channels of the pipettor as set forth in claim 15, further comprising:
said chassis defining a plurality of adapter channels as said plurality of pipette tip receivers into each of which a pipette tip may be fitted.

20. An adapter for a pipettor that enables use of a number of pipette tips different than a number of pipette channels of the pipettor as set forth in claim 15, further comprising:
each of said plurality of said pipette tip receivers defining a central channel; and
said chassis defining a separate channel as said pipette channel engager, said separate channel in communication with said central channels; whereby
flow through said separate channel of said chassis is transmitted to each said central channels of said plurality of said pipette tip receivers.

21. An adapter for a pipettor that enables use of a number of pipette tips different than a number of pipette channels of the pipettor as set forth in claim 20, further comprising:
said separate channel having an open end;
said open end of said separate channel circumscribed by a sealing member; whereby
a seal may be created between said pipette channel engager and said corresponding pipette channel by aligned compression of the adapter against the pipettor to enable controlled flow through said corresponding pipette channel to said separate channel.

22. An adapter for a pipettor that enables use of a number of pipette tips different than a number of pipette channels of the pipettor as set forth in claim 20, further comprising:
said separate channel having an open end;
said open end of said separate channel sealable by a sealing member circumscribing an opening of said corresponding pipette channel to provide sealing between said pipette channel engager and said corresponding pipette channel.

23. An adapter for a pipettor that enables use of a number of pipette tips different than a number of pipette channels of the pipettor as set forth in claim 15, further comprising:
said plurality of pipette tip receivers being in number selected from the group of numbers consisting of two, three, four and sixteen.

24. An adapter for a pipettor that enables use of a number of pipette tips different than a number of pipette channels of the pipettor, the adapter comprising:
a chassis, said chassis being generally flat and having a first side and an opposite side;
a plurality of pipette tip receivers coupled to said first side of said chassis, said plurality of pipette tip receivers each having a central channel and adapted to engage a pipette tip;
said chassis defining a separate channel on said opposite side of said chassis adapted to engage a corresponding pipette channel of the pipettor, said separate channel in communication with each of said central channels of said plurality of pipette tip receivers such that flow through said separate channel of said chassis is transmitted to each of said central channels of said plurality of pipette tip receivers;
said separate channel having an open end; and
said open end of said separate channel sealable such that a seal may be created between said separate channel and said corresponding pipette channel by aligned compression of the adapter against the pipettor to enable controlled flow through said corresponding pipette channel to said separate channel; whereby
a plurality of pipette tips is correspondingly engageable by said plurality of pipette tip receivers and flow through said plurality of central channels is controlled by flow through said separate channel caused by flow through said corresponding pipette channel.

25. An adapter for a pipettor that enables use of a number of pipette tips different than a number of pipette channels of the pipettor as set forth in claim 24, the adapter further comprising:
each of said pipette tip receivers being a projection defining said central channel and about which a pipette tip may be fitted; and
first and second seals circumscribing each of said plurality of pipette tip receivers such that a pipette tip may be engaged by each of said plurality of pipette tip receivers by friction fit over said first and second seals.

26. An adapter for a pipettor that enables use of a number of pipette tips different than a number of pipette channels of the pipettor as set forth in claim 24, the adapter further comprising:
said chassis defining said plurality of central channels as said plurality of pipette tip receivers, each of said plurality of central channels adapted to receive a pipette tip and into which a pipette tip may be fitted; and
said open end of said separate channel being sealable by a sealing member circumscribing a corresponding opening of said corresponding pipette channel to provide sealing between said separate channel and said corresponding pipette channel.

27. An adapter for a pipettor that enables use of a number of pipette tips different than a number of pipette channels of the pipettor as set forth in claim 24, further comprising:
said plurality of pipette tip receivers being in number selected from the group of numbers consisting of two, three, four and sixteen.
